(19) United States
(12) Patent Application Publication
(10) Pub. No.: US 2022/0290277 A1
(43) Pub. Date: Sep. 15, 2022

(54) GRAIN-ORIENTED ELECTRIC STEEL SHEET AND MANUFACTURING METHOD THEREFOR

(71) Applicant: POSCO, Pohang-si, Gyeongsangbuk-do (KR)

(72) Inventors: Dae-Hyun SONG, Pohang-si, Gyeongsangbuk-do (KR); June Soo PARK, Pohang-si, Gyeongsangbuk-do (KR); Il-Nam YANG, Pohang-si, Gyeongsangbuk-do (KR)

(21) Appl. No.: 17/297,115

(22) PCT Filed: Nov. 26, 2019
(86) PCT No.: PCT/KR2019/016386

§ 371 Date: May 26, 2021

(30) Foreign Application Priority Data
Nov. 30, 2018 (KR) 10-2018-0153119

(51) Int. Cl. C22C 38/30; C22C 38/00; C22C 38/02; C22C 38/06; C22C 38/04; C21D 8/02; C21D 3/04; C21D 9/46

(52) U.S. Cl. CPC C22C 38/30; C22C 38/002; C22C 38/02; C22C 38/06; C22C 38/008; C22C 38/04; C21D 8/0205; C21D 8/0226; C21D 8/0236; C21D 3/04; C21D 9/46; C21D 2201/05

(57) ABSTRACT

A grain-oriented electrical steel sheet according to an embodiment of the present invention includes: Si at 2.0 to 6.0 wt%, Mn at 0.12 to 1.0 wt%, Sb at 0.01 to 0.05 wt%, Sn at 0.03 to 0.08 wt%, Cr at 0.01 to 0.2 wt%, and the balance of Fe and inevitable impurities, and satisfies Formula 1 below.

4×[Cr]−0.1×[Mn]≥0.5×([Sn]+[Sb]) [Formula 1]

(In Formula 1, [Cr], [Mn], [Sn], and [Sb] represent contents (wt%) of Cr, Mn, Sn, and Sb, respectively.)

### TECHNICAL FIELD

The present invention relates to a grain-oriented electrical steel sheet and a manufacturing method thereof. Specifically, the present invention relates to a grain-oriented electrical steel sheet and a manufacturing method thereof in which magnetism is improved by appropriately controlling contents of Mn, Cr, Sn, and Sb.

### BACKGROUND ART

A grain-oriented electrical steel sheet is a soft magnetic material having an excellent magnetic property in one direction or a rolling direction because it shows Goss texture in which the texture of the steel sheet in the rolling direction is {110}<001>, and complex processes such as component control in steel making, slab reheating and hot rolling process factor control in hot rolling, hot-rolled sheet annealing heat treatment, cold rolling, primary recrystallization annealing, and secondary recrystallization annealing are required to express such a texture, and these processes must be very precisely and strictly managed. In addition to the aforementioned processes, it is known that reduction of a sheet thickness, addition of an alloying element such as Si that increases specific resistance, application of tension in a steel sheet, reduction of roughness of a steel sheet surface, refinement of secondary recrystallized grain size, magnetic domain refinement, etc. are effective in improving iron loss of a grain-oriented electrical steel sheet. Among them, a method of increasing a Si content is mainly known as a technique for improving iron loss by increasing specific resistance. However, as the Si content increases, brittleness of a material significantly increases, resulting in a sharp degradation in processability, and thus there is a limit in increasing the Si content. In order to improve processability of a grain-oriented electrical steel sheet with a high Si content, a method has been proposed to improve cold rolling by providing a separate layer with a high Si content on a surface layer. However, there is a problem that not only a process therefor is difficult and a manufacturing cost therefor is high, but also peeling of the surface layer may occur. In a case of manufacturing a grain-oriented electrical steel sheet with a high Si content, a method capable of rolling at a specific temperature and reduction ratio has been proposed. However, in actual production, a burden of manufacturing cost is increased due to control of the temperature and reduction ratio, so there is a limit to applying it to commercial production. As a method of manufacturing a high-silicon grain-oriented electrical steel sheet, a technique for forming a Goss structure with excellent integration by performing warm rolling in a lower temperature range than a primary recrystallization temperature after hot rolling has been proposed, but since the technique requires additional warm rolling equipment, there is an increase in manufacturing cost, and additional oxidation occurs on a surface layer of a cold-rolled sheet during warm rolling, thereby deteriorating surface characteristics of a final manufactured grain-oriented electrical steel sheet. A technique of appropriately forming an oxide layer of a decarburized annealing sheet by adding elements such as Sn, Sb, and Cr to a directional electrical steel sheet has been proposed. However, in this technique, it has been explained that Mn is a cause of severely damaging a texture in a secondary recrystallization annealing process, and thus a content of Mn is controlled to be low. Due to this, there is a limit to magnetism.

### DISCLOSURE

### Description of the Drawings

A grain-oriented electrical steel sheet and a manufacturing method thereof are provided. Specifically, a grain-oriented electrical steel sheet and a manufacturing method thereof in which magnetism is improved by appropriately controlling contents of Mn, Cr, Sn, and Sb, are provided.

A grain-oriented electrical steel sheet according to an embodiment of the present invention includes: Si at 2.0 to 6.0 wt%, Mn at 0.12 to 1.0 wt%, Sb at 0.01 to 0.05 wt%, Sn at 0.03 to 0.08 wt%, Cr at 0.01 to 0.2 wt%, and the balance of Fe and inevitable impurities, and satisfies Formula 1 below.

4×[Cr]−0.1×[Mn]≥0.5×([Sn]+[Sb]) [Formula 1]

(In Formula 1, [Cr], [Mn], [Sn], and [Sb] represent contents (wt%) of Cr, Mn, Sn, and Sb, respectively.)

The grain-oriented electrical steel sheet according to the embodiment of the present invention may further include Al at 0.005 to 0.04 wt% and P at 0.005 to 0.045 wt%.

The grain-oriented electrical steel sheet according to the embodiment of the present invention may further include Co at 0.1 wt% or less.

The grain-oriented electrical steel sheet according to the embodiment of the present invention may further include C at 0.01 wt% or less, N at 0.01 wt% or less, and S at 0.01 wt% or less.

Another embodiment of the present invention provides a manufacturing method of a grain-oriented electrical steel sheet, including: heating a slab including Si at 2.0 to 6.0 wt%, C at 0.01 to 0.15 wt%, Mn at 0.12 to 1.0 wt%, Sb at 0.01 to 0.05 wt%, Sn at 0.03 to 0.08 wt%, Cr at 0.01 to 0.2 wt%, and the balance of Fe and inevitable impurities, and satisfying Formula 1 below; hot-rolling the slab to manufacture a hot rolled sheet; cold-rolling the hot-rolled sheet to produce a cold-rolled sheet; primary recrystallization annealing the cold-rolled sheet; and secondary recrystallization annealing the cold-rolled sheet subjected to the primary recrystallization annealing.

The slab may satisfy Formula 2 below.

2×(1.3−[Mn])−2×(3.4−[Si])≤50×[C]≤3×(1.3−[Mn])−2×(3.4−[Si]) [Formula 2]

(In Formula 2, [Mn], [Si], and [C] represent contents (wt%) of Mn, Si, and C in the slab, respectively.)

The slab may satisfy Formula 3 below.

5×(1.3−[Mn])−4×(3.4−[Si])−0.5≤100 ×[C]≤5×(1.3−[Mn])−4×(3.4−[Si])+0.5 [Formula 3]

(In Formula 3, [Mn], [Si], and [C] represent contents (wt%) of Mn, Si, and C in the slab, respectively.)

The heating of the slab may include heating at a temperature of 1250° C. or less.

The manufacturing of the cold-rolled sheet may include cold-rolling once, or cold-rolling two times or more including intermediate annealing.

The primary recrystallization annealing may include decarburizing and nitriding, and the nitriding may be performed after the decarburizing, or the decarburizing may be performed after the nitriding, or the decarburizing and the nitriding may be simultaneously performed.

The manufacturing method of the grain-oriented electrical steel sheet may further include, after the primary recrystallization annealing, applying an annealing separating agent. The secondary recrystallization annealing may include completing secondary recrystallization at a temperature of 900 to 1210 ° C.

According to the grain-oriented electrical steel sheet according to the embodiment of the present invention, it is possible to improve iron loss along with imparting grain growth inhibiting ability through increase in specific resistance and formation of a Mn-based sulfide by containing a relatively large amount of Mn.

In addition, according to the grain-oriented electrical steel sheet according to the embodiment of the present invention, it is possible to improve magnetism by promoting formation of an oxide layer during decarburization and assisting grain growth inhibiting ability, by appropriately controlling contents of

Cr, Sn, and Sb.

### Mode for Invention

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Therefore, a first part, component, area, layer, or section to be described below may be referred to as second part, component, area, layer, or section within the range of the present invention.

The technical terms used herein are to simply mention a particular embodiment and are not meant to limit the present invention. An expression used in the singular encompasses an expression of the plural, unless it has a clearly different meaning in the context. In the specification, it is to be understood that the terms such as “including”, “having”, etc., are intended to indicate the existence of specific features, regions, numbers, stages, operations, elements, components, and/or combinations thereof disclosed in the specification, and are not intended to preclude the possibility that one or more other features, regions, numbers, stages, operations, elements, components, and/or combinations thereof may exist or may be added.

When referring to a part as being “on” or “above” another part, it may be positioned directly on or above another part, or another part may be interposed therebetween. In contrast, when referring to a part being “directly above” another part, no other part is interposed therebetween.

Unless otherwise defined, all terms used herein, including technical or scientific terms, have the same meanings as those generally understood by those with ordinary knowledge in the field of art to which the present invention belongs. Terms defined in commonly used dictionaries are further interpreted as having meanings consistent with the relevant technical literature and the present disclosure, and are not to be construed as having idealized or very formal meanings unless defined otherwise.

Unless mentioned in a predetermined way, % represents wt%, and 1 ppm is 0.0001 wt%.

In embodiments of the present invention, inclusion of an additional element means replacing the remaining iron (Fe) by an additional amount of the additional elements.

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

A grain-oriented electrical steel sheet according to an embodiment of the present invention includes: Si at 2.0 to 6.0 wt%, Mn at 0.12 to 1.0 wt%, Sb at 0.01 to 0.05 wt%, Sn at 0.03 to 0.08 wt%, Cr at 0.01 to 0.2 wt%, and the balance of Fe and inevitable impurities.

Hereinafter, a reason of limiting the alloy components will be described.

Si at 2.0 to 6.0 wt%

Silicon (Si) is a basic composition of an electric steel sheet, and it serves to reduce core loss by increasing specific resistance of a material. When a Si content is too small, specific resistance decreases, and vortex loss increases, resulting in deterioration of iron loss characteristics, and further, during primary recrystallization annealing, phase transformation between ferrite and austenite becomes active and thus primary recrystallization texture is severely damaged. In addition, phase transformation between ferrite and austenite occurs during secondary recrystallization annealing, resulting in unstable secondary recrystallization and severe damage to {110} Goss texture. On the other hand, when the Si content is excessive, oxide layers of SiO₂ and Fe₂SiO₄ are excessively and densely formed during the primary recrystallization annealing, so that decarburization behavior is delayed, and the phase transformation between ferrite and austenite continuously occurs during the first recrystallization annealing treatment, thus the primary recrystallization texture may be severely damaged. In addition, due to the delaying effect of the decarburization behavior due to the formation of the dense oxide layer described above, nitriding behavior is also delayed, so that nitrides such as (Al,Si,Mn)N and AlN may not be sufficiently formed, and thereby sufficient grain inhibiting ability required for the secondary recrystallization during high temperature annealing may not be secured.

In addition, when an excessive amount of Si is included, brittleness, which is a mechanical characteristic, increases and toughness decreases, so that during a rolling process, an incidence of sheet breakage increases, and weldability between the sheets is deteriorated, so that easy workability may not be secured. As a result, when the Si content is not controlled in the above-mentioned predetermined range, the secondary recrystallization becomes unstable, seriously deteriorating magnetic characteristics, and deteriorating workability. Therefore, Si may be included in an amount of 2.0 to 6.0 wt%. Specifically, it may be included in an amount of 3.0 to 5.0 wt%.

Mn at 0.12 to 1.0 wt%

Manganese (Mn) decreases eddy current loss by increasing specific resistance like Si, thereby reducing total iron loss, and reacts with S in a quenching state to form Mn-based sulfides and reacts with nitrogen introduced by nitriding along with Si to form a precipitate of (Al,Si,Mn)N, so that it is an important element in inhibiting growth of primary recrystallized grains and causing secondary recrystallization. The embodiment of the present invention is intended to improve the entire iron loss by increasing the specific resistance due to the increase of the Mn content, and to impart grain growth inhibiting ability by the Mn-based sulfide. When Mn is properly included within the aforementioned Si content range, iron loss may be improved. However, when an excessive amount of Mn was included, the iron loss is not improved, resulting in intensifying the amount of austenite phase transformation, and deteriorating the magnetic characteristic due to decarburization for a long time. Therefore, Mn may be included in an amount of 0.12 to 1.0 wt%. Specifically, Mn may be included in an amount of 0.13 to 1.0 wt%. More specifically, it may be included in an amount of 0.21 to 0.95 wt%. More specifically, it may be included in an amount of 0.25 to 0.95 wt%. More specifically, it may be included in an amount of 0.3 to 0.95 wt%. In the embodiment of the present invention, even if a relatively large amount of Mn is added due to the appropriate addition of Si and C together with Mn, the texture is not severely damaged in the secondary recrystallization annealing process.

Sb at 0.01 to 0.05 wt%

Antimony (Sb) inhibits grain growth by segregation on grain boundaries, and stabilizes the secondary recrystallization. However, since a melting point thereof is low, it is easily diffused to a surface during the primary recrystallization annealing, thereby interfering with nitriding according to the decarburization, oxide layer formation, and nitrification. When too little Sb is included, it is difficult to properly obtain the above-described effect. Conversely, when an excessive amount of Sb is added, it may hinder decarburization and inhibit the formation of the oxide layer that is the basis of base coating. Therefore, Sb may be included in an amount of 0.01 to 0.05 wt%. Specifically, it may be contained in an amount of 0.01 to 0.04 wt%.

Sn at 0.03 to 0.08 wt%

Tin (Sn) is an element of grain boundary segregation and serves as a grain growth inhibitor because it is an element that hinders movement of the grain boundaries. In the embodiment of the present invention, since grain growth inhibiting ability for smooth secondary recrystallization behavior during the secondary recrystallization annealing is insufficient, Sn, which interferes with the movement of the grain boundaries by being segregated at the grain boundaries, is necessarily required. When too little Sn is included, it is difficult to properly obtain the above-described effect. Conversely, when an excessive amount of Sn is added, the grain growth inhibiting ability is too strong to obtain stable secondary recrystallization. Therefore, Sn may be included in an amount of 0.03 to 0.08 wt%. Specifically, it may be included in an amount of 0.04 to 0.08 wt%.

Cr at 0.01 to 0.2 wt%

Chromium (Cr) promotes formation of a hard phase in the hot-rolled sheet, promotes formation of {110}<001>of the Goss texture during the cold rolling, and promotes decarburization during the primary recrystallization annealing process, thereby reducing an austenite phase transformation maintaining time so that a phenomenon that the texture is damaged due to increase of the austenite phase transformation maintaining time may be prevented. In addition, since it promotes the formation of the oxide layer on the surface formed during the primary recrystallization annealing process, it is possible to solve drawbacks in which the oxide layer formation is inhibited by Sn and Sb among alloy elements used as a grain growth auxiliary inhibitor. When Cr is included in a small amount, it is difficult to properly obtain the above-described effect. Conversely, when an excessive amount of Cr is added, since it promotes the formation of a more dense oxide layer when the oxide layer is formed during the primary recrystallization annealing process, rather, the formation of the oxide layer may be deteriorated, and decarburization and nitridation may be hindered. Therefore, Cr may be included in an amount of 0.01 to 0.2 wt%. Specifically, C may be included in an amount of 0.02 to 0.1 wt%.

The oriented electrical steel sheet according to the embodiment of the present invention satisfies Formula 1.

4×[Cr]−0.1×[Mn]≥0.5×([Sn]+[Sb]) [Formula 1]

(In Formula 1, [Cr], [Mn], [Sn], and [Sb] represent contents (wt%) of Cr, Mn, Sn, and Sb, respectively.)

By appropriately controlling the contents of Cr, Mn, Sn, and Sb as in Formula 1, the densification of the oxide layer during the primary recrystallization annealing process is prevented, and the decarburization thereof is promoted, thereby reducing or preventing damage to the Goss texture due to the austenite phase transformation. In addition, stable base coating may be made by inducing the proper formation of the oxide layer formed during the primary recrystallization annealing process.

The grain-oriented electrical steel sheet according to the embodiment of the present invention may further include Al at 0.005 to 0.04 wt% and P at 0.005 to 0.045 wt%. As described above, when the additional elements are further included, they replace the balance of Fe.

Al at 0.005 to 0.04 wt%

In addition to AlN finely precipitated during the hot rolling and hot-rolled sheet annealing, since nitrogen ions introduced by ammonia gas in the annealing process after the cold rolling are combined with Al, Si, and Mn present in a solid solution state in the steel to form nitrides such as (Al,Si,Mn)N and AlN, Aluminum (Al) acts as a powerful grain growth inhibitor

When Al is added and when the amount of Al is too small, the number and volume to be formed are at a very low level, so a sufficient effect as an inhibitor may not be expected. Conversely, when the Al content is excessive, coarse nitrides are formed, thereby reducing ability to inhibit grain growth. Therefore, when Al is further included, Al may be further included in an amount of 0.005 to 0.04 wt%. Specifically, it may be included in an amount of 0.01 to 0.035 wt%.

P at 0.005 to 0.045 wt%

Phosphorus (P) may be segregated on the grain boundary to hinder the movement of the grain boundary, and simultaneously may inhibit grain growth, and improves {110}<001>texture in a microstructure. When an addition amount of P is is too small, there is no effect of addition. Conversely, when the addition amount thereof is too large, brittleness increases and rollability is considerably deteriorated. Therefore, when P is further included, P may be further included in an amount of 0.005 to 0.045 wt%. Specifically, C may be contained in an amount of 0.01 to 0.04 wt%.

The grain-oriented electrical steel sheet according to the embodiment of the present invention may further include Co at 0.1 wt% or less.

Co at 0.1 wt% or less

Cobalt (Co) is an effective alloying element that increases a magnetic flux density by increasing magnetization of iron, and is an alloying element that decreases iron loss by increasing specific resistance thereof. When Co is properly added, the above-mentioned effect may be additionally obtained.

When too much Co is added, the amount of austenite phase transformation increases, which may negatively affect microstructure, precipitates, and texture. Therefore, when Co is added, it may be further included in an amount of 0.1 wt% or less. Specifically, it may be further included in an amount of 0.005 to 0.05 wt%.

The grain-oriented electrical steel sheet according to the embodiment of the present invention may further include C at 0.01 wt% or less, N at 0.01 wt% or less, and S at 0.01 wt% or less.

C at 0.01 wt% or less

Carbon (C) is an element that causes phase transformation between ferrite and austenite to refine crystal grains and improve elongation, and is an essential element for improving rollability of electrical steel sheets with strong brittleness and poor rollability. However, when it remains in the grain-oriented electrical steel sheet to be finally manufactured, it is an element that deteriorates magnetic properties by precipitating carbides formed due to magnetic aging effect in the steel sheet. Therefore, the grain-oriented electrical steel sheet to be finally manufactured may further include C in an amount of 0.01 wt% or less. Specifically, C may be included in an amount of 0.005 wt% or less. More specifically, C may be included in an amount of 0.003 wt% or less.

In a slab, C may be included in an amount of 0.01 to 0.15 wt%. When too little C is included in the slab, the phase transformation between ferrite and austenite is not sufficiently generated, causing unevenness of the slab and hot-rolled microstructure, thereby degrading the cold rolling properties. Meanwhile, after the hot-rolled sheet annealing heat treatment, by activating fixation of dislocations during the cold rolling by residual carbon present in the steel sheet, and by increasing a shear strain zone to increase a generation site of Goss nuclei and by increasing a fraction of Goss grains in the primary recrystallized microstructure, the more C, the better, but when too much C is included in the slab, sufficient decarburization may be obtained, and thus the density of the Goss texture is lowered, so that the secondary recrystallized texture is severely damaged, and further, when the grain-oriented electrical steel sheet is applied to a power device, the magnetic properties are deteriorated due to magnetic aging. Therefore, in the slab, C may be included in an amount of 0.01 to 0.15 wt%. Specifically, C may be included in an amount of 0.02 to 0.08 wt%.

In addition, in the embodiment of the present invention, when the content of C to the contents of Mn and Si satisfies Formula 2 below, the magnetism may be further improved. In this case, the content of C means the content of C in the slab.

2×(1.3−[Mn])−2×(3.4−[Si])≤50×[C]≤3×(1.3−[Mn])−2×(3.4×[Si]) [Formula 2]

(In Formula 2, [Mn], [Si], and [C] represent contents (wt%) of Mn, Si, and C in the slab, respectively.)

Specifically, they may satisfy Formula 3.

5×(1.3−[Mn])−4×(3.4−[Si])−0.5 ≤100×[C]≤5×(1.3−[Mn])−4×(3.4−[Si])+0.5 [Formula 3]

(In Formula 3, [Mn], [Si] and [C] represent contents (wt%) of Mn, Si, and C in the slab, respectively.)

N at 0.01 wt% or less

Nitrogen (N) is an element that reacts with Al to form AlN. When too much N is additionally added, it causes a surface defect called Blister due to nitrogen diffusion in the process after the hot rolling, and too much nitride is formed in the slab state, so that rolling may become difficult and the subsequent process may be complicated. Meanwhile, the additional N required to form nitrides such as (Al,Si,Mn)N, AlN, and (Si,Mn)N is supplemented by nitriding in the steel by using ammonia gas in the annealing process after the cold rolling. Thereafter, since some of N is removed in the secondary recrystallization annealing process, the N contents of the slab and the final manufactured grain-oriented electrical steel sheet are substantially the same. When N is additionally added, it may be further included in an amount of 0.01 wt% or less. Specifically, it may be included in an amount of 0.005 wt% or less. More specifically, it may be included in an amount of 0.003 wt% or less.

S at 0.01 wt% or less

Sulfur (S) serves to inhibit grain growth as precipitates of MnS are formed in the slab. However, it is difficult to control the microstructure in subsequent processes due to segregation in a center of the slab during casting. In the present invention, since MnS is not used as a main grain growth inhibiting agent, there is no need to add an excessive amount of S. However, when a predetermined amount of S is added, it may be helpful in inhibiting grain growth. When S is added, S may be further included in an amount of 0.01 wt% or less. Specifically, S may be included in an amount of 0.005 wt% or less. More specifically, it may be included in an amount of 0.003 wt% or less.

The balance of Fe is included. Inevitable impurities may also be included. The inevitable impurities mean impurities that are unavoidably mixed of steel making and in the manufacturing process of the grain-oriented electrical steel sheet. Since the inevitable impurities are widely known, a detailed description thereof is omitted. In the embodiment of the present invention, the addition of elements other than the above-described alloy components is not excluded, and various elements may be included within a range that does not hinder the technical concept of the present invention. When the additional elements are further included, they replace the balance of Fe.

A manufacturing method of the grain-oriented electrical steel sheet according to the embodiment of the present invention includes heating a slab; hot-rolling the slab to manufacture a hot-rolled sheet; cold- rolling the hot-rolled sheet to manufacture a cold-rolled sheet; primary recrystallization annealing the cold-rolled sheet; and secondary recrystallization annealing the cold-rolled sheet subjected to the primary recrystallization annealing.

First, the slab is heated. Since the alloy composition of the slab has been described in relation to the alloy composition of the grain-oriented electrical steel sheet, a duplicate description will be omitted. Specifically, the slab includes Si at 2.0 to 6.0 wt%, C at 0.01 to 0.15 wt%, Mn at 0.12 to 1.0 wt%, Sb at 0.01 to 0.05 wt%, Sn at 0.03 to 0.08 wt%, Cr at 0.01 to 0.2 wt%, and the balance of Fe and inevitable impurities, and may satisfy Formula 1 below.

Describing back the manufacturing method, when the slab is heated, it may be heated at 1250° C. or less. Accordingly, the precipitates of Al-based nitride or Mn-based sulfide may be incompletely dissolved or completely dissolved according to the chemical equivalent relationship between dissolved Al and N, and M and S.

Next, when the slab is completely heated, hot-rolling is performed to manufacture a hot-rolled sheet. A thickness of the hot-rolled sheet may be 1.0 to 3.5 mm.

Next, hot-rolled sheet annealing may be performed. In the hot-rolled sheet annealing, a crack temperature may be 800 to 1300° C. When the hot-rolled sheet annealing is performed, it is possible to homogenize the uneven microstructure and precipitate of the hot-rolled sheet, but it is also possible to omit this.

Next, the hot-rolled sheet is cold-rolled to manufacture a cold-rolled sheet. In the cold-rolling, one cold-rolling or two or more cold-rollings including intermediate annealing may be performed. A thickness of the cold-rolled sheet may be 0.1 to 0.5 mm. When the cold-rolling is performed, a cold-rolling reduction ratio thereof may be 87% or more. This is because the density of the Goss texture increases as the cold-rolling reduction ratio increases. However, it is also possible to apply a lower cold-rolling reduction ratio.

Next, the cold-rolled sheet is subjected to primary recrystallization annealing. In this case, the primary recrystallization annealing may include decarburizing and nitriding. The decarburizing and the nitriding may be performed in any order. That is, the nitriding may be performed after the decarburizing, the decarburizing may be performed after the nitriding, or the decarburizing and the nitriding may be simultaneously performed. In the decarburizing, C may be decarburized at 0.01 wt% or less. Specifically, C may be decarburized at 0.005 wt% or less. In the nitriding, N may be nitrided at 0.01 wt% or more.

The cracking temperature in the primary recrystallization annealing may be 840° C. to 900° C.

After the primary recrystallization annealing, an annealing separating agent may be applied to the steel sheet. Since the annealing separating agent is widely known, a detailed description will be omitted. For example, the annealing separating agent including MgO as a main component may be used.

Next, the secondary recrystallization annealing is performed on the cold-rolled sheet subjected to the primary recrystallization annealing.

The purpose of the secondary recrystallization annealing is largely formation of {110}<001>texture by the secondary recrystallization, insulation-imparting by the formation of a glassy film by reaction between the oxide layer formed during the primary recrystallization annealing and MgO, and removal of impurities that degrades magnetic properties. In the method of the secondary recrystallization annealing, in the heating section before the secondary recrystallization occurs, the mixture of nitrogen and hydrogen is maintained to protect the nitride, which is a particle growth inhibitor, so that the secondary recrystallization may develop well, and in the cracking after the secondary recrystallization is completed, impurities are removed by maintaining it in a 100% hydrogen atmosphere for a long time.

In the secondary recrystallization annealing, the secondary recrystallization may be completed at a temperature of 900 to 1210° C.

The grain-oriented electrical steel sheet according to the embodiment of the present invention has particularly excellent iron loss and magnetic flux density characteristics. In the grain-oriented electrical steel sheet according to the embodiment of the present invention, the magnetic flux density (B₈) may be 1.89 T or more, and the iron loss (W_{17/50}) may be 0.85 W/kg or less. In this case, the magnetic flux density (B₈) is a magnetic flux density (Tesla) induced under a magnetic field of 800 A/m, and the iron loss (W_{17/50}) is an iron loss (W/kg) induced in 1.7 Tesla and 50 Hz conditions. Specifically, in the grain-oriented electrical steel sheet according to the embodiment of the present invention, the magnetic flux density (B₈) may be 1.895 T or more, and the iron loss (W_{17/50}) may be 0.83 W/kg or less. More specifically, the magnetic flux density (B₈) of the grain-oriented electrical steel sheet may be 1.895 to 1.92 T, and the iron loss (W_{17/50}) may be 0.8 to 0.83 W/kg or less.

Hereinafter, specific examples of the present invention will be described. However, the following examples are only specific examples of the present invention, and the present invention is not limited to the following examples.

### EXAMPLE 1

A slab that includes Si at 3.4 wt%, S at 0.004 wt%, N at 0.004 wt%, Al at 0.029 wt%, P at 0.032 wt%; Mn, C, Sn, Sb, and Cr changed as shown in Table 1 below; and the balance of Fe and inevitable impurities was heated at a temperature of 1140° C., and then hot-rolled to a thickness of 2.3 mm. The hot-rolled sheet was heated at a temperature of 1080° C., maintained at 910° C. for 160 seconds, and quenched in water. The hot-rolled annealing sheet was pickled and rolled once to a thickness of 0.23 mm, and the cold-rolled sheet was maintained for 200 seconds in a humid hydrogen, nitrogen, and ammonia mixed gas atmosphere at a temperature of 850° C., and then simultaneously decarbonized, nitrided, annealed, and heat-treated so that the nitrogen content was 190 ppm and the carbon content was 30 ppm.

The final annealing was performed by applying MgO, an annealing separating agent, to this steel sheet, and in this case, the final annealing was performed in a mixed atmosphere of 25 vol% nitrogen+75 vol% hydrogen until 1200° C., and after reaching 1200° C., it was maintained for 10 hours or more in a 100 vol% hydrogen atmosphere and then furnace-cooled. Table 2 shows the measured magnetic characteristics for each condition.

TABLE 1

| Steel type | | | | | | |
|---|---|---|---|---|---|---|
| (wt %) | Mn | C | Sb | Sn | Cr | Remarks |
| 1 | 0.5 | 0.04 | 0.02 | 0.07 | 0.04 | Inventive material |
| 2 | 0.51 | 0.04 | 0.02 | 0.07 | 0.07 | Inventive material |
| 3 | 0.49 | 0.04 | 0.01 | 0.03 | 0.01 | Comparative material |
| 4 | 0.52 | 0.04 | 0.05 | 0.03 | 0.09 | Inventive material |
| 5 | 0.5 | 0.04 | 0.01 | 0.05 | 0.01 | Comparative material |
| 6 | 0.49 | 0.04 | 0.05 | 0.05 | 0.05 | Inventive material |
| 7 | 0.71 | 0.03 | 0.02 | 0.07 | 0.04 | Inventive material |
| 8 | 0.7 | 0.03 | 0.02 | 0.07 | 0.07 | Inventive material |
| 9 | 0.72 | 0.03 | 0.04 | 0.03 | 0.01 | Comparative material |
| 10 | 0.72 | 0.03 | 0.05 | 0.03 | 0.09 | Inventive material |
| 11 | 0.69 | 0.03 | 0.01 | 0.05 | 0.01 | Comparative material |
| 12 | 0.71 | 0.03 | 0.05 | 0.05 | 0.05 | Inventive material |
| 13 | 0.92 | 0.028 | 0.02 | 0.07 | 0.04 | Inventive material |
| 14 | 0.91 | 0.028 | 0.02 | 0.07 | 0.07 | Inventive material |
| 15 | 0.92 | 0.028 | 0.04 | 0.03 | 0.02 | Comparative material |
| 16 | 0.9 | 0.028 | 0.05 | 0.03 | 0.09 | Inventive material |
| 17 | 0.91 | 0.028 | 0.01 | 0.05 | 0.02 | Comparative material |

TABLE 2

| | | | Whether | Whether | | Magnetic | |
|---|---|---|---|---|---|---|---|
| | | | Formula | Formula | Iron loss | flux | |
| Steel type | 4 × [Cr]- | 0.5 × | 2 is | 3 is | (W17/50, | density | |
| (wt %) | 0.1 × [Mn] | ([Sn] + [Sb]) | satisfied | satisfied | W/kg) | (B8, T) | |
| 1 | 0.11 | 0.045 | O | O | 0.814 | 1.909 | Inventive |
| | | | | | | | material |
| 2 | 0.229 | 0.045 | O | O | 0.817 | 1.908 | Inventive |
| | | | | | | | material |
| 3 | −0.009 | 0.02 | O | O | 0.879 | 1.871 | Comparative |
| | | | | | | | material |
| 4 | 0.308 | 0.04 | O | O | 0.815 | 1.899 | Inventive |
| | | | | | | | material |
| 5 | −0.01 | 0.03 | O | O | 0.889 | 1.888 | Comparative |
| | | | | | | | material |
| 6 | 0.151 | 0.05 | O | O | 0.817 | 1.906 | Inventive |
| | | | | | | | material |
| 7 | 0.089 | 0.045 | O | O | 0.813 | 1.894 | Inventive |
| | | | | | | | material |
| 8 | 0.21 | 0.045 | O | O | 0.808 | 1.894 | Inventive |
| | | | | | | | material |
| 9 | −0.032 | 0.035 | O | O | 0.875 | 1.88 | Comparative |
| | | | | | | | material |
| 10 | 0.288 | 0.04 | O | O | 0.811 | 1.907 | Inventive |
| | | | | | | | material |
| 11 | −0.029 | 0.03 | O | O | 0.887 | 1.884 | Comparative |
| | | | | | | | material |
| 12 | 0.129 | 0.05 | O | O | 0.804 | 1.913 | Inventive |
| | | | | | | | material |
| 13 | 0.068 | 0.045 | X | X | 0.823 | 1.887 | Inventive |
| | | | | | | | material |
| 14 | 0.189 | 0.045 | X | X | 0.817 | 1.895 | Inventive |
| | | | | | | | material |
| 15 | −0.012 | 0.035 | X | X | 0.879 | 1.882 | Comparative |
| | | | | | | | material |
| 16 | 0.27 | 0.04 | X | X | 0.807 | 1.898 | Inventive |
| | | | | | | | material |
| 17 | −0.011 | 0.03 | X | X | 0.878 | 1.879 | Comparative |
| | | | | | | | material |

As shown in Table 1 and Table 2, it can be confirmed that the inventive material in which the relationship between Mn, Cr, Sn, and Sb is properly controlled has excellent magnetism. Meanwhile, it can be seen that the comparative material that does not satisfy the relationship between Mn, Cr, Sn, and Sb has poor magnetism.

### EXAMPLE 2

A slab that includes Si at 3.3 wt%, Mn at 0.3 wt%, Al at 0.026 wt%, N at 0.004 wt%, S at 0.004 wt%, Sb at 0.03 wt%, Sn at 0.06 wt%, P at 0.03 wt%, Cr at 0.04 wt%, Co at 0.02 wt%; the content of C changed as shown in Table 3; and the balance of Fe and other inevitable impurities was heated at a temperature of 1150° C. and then hot-rolled to a thickness of 2.3 mm. The hot-rolled sheet was heated at a temperature of 1080° C., maintained at 890° C. for 160 seconds, and quenched in water. The hot-rolled annealing sheet was pickled and rolled once to a thickness of 0.23 mm, and the cold-rolled sheet was maintained for 200 seconds in a humid hydrogen, nitrogen, and ammonia mixed gas atmosphere at a temperature of 860° C., and then simultaneously decarbonitized, nitrided, annealed, and heat-treated so that the nitrogen content was 180 ppm and the carbon content was 30 ppm.

The final annealing was performed by applying MgO, an annealing separating agent, to this steel sheet, and in this case, the final annealing was performed in a mixed atmosphere of 25 vol% nitrogen+75 vol% hydrogen until 1200° C., and after reaching 1200° C., it was maintained for 10 hours or more in a 100 vol% hydrogen atmosphere and then furnace-cooled. Table 3 shows the measured magnetic characteristics for each condition.

TABLE 3

| | | Whether | Whether | | Magnetic |
|---|---|---|---|---|---|
| Steel | | Formula 2 is | Formula 3 is | Iron loss | flux density |
| type | C | satisfied | satisfied | (W17/50) | B8 |
| 18 | 0.014 | X | X | 0.889 | 1.898 |
| 19 | 0.021 | X | X | 0.887 | 1.902 |
| 20 | 0.023 | X | X | 0.882 | 1.902 |
| 21 | 0.026 | X | X | 0.874 | 1.902 |
| 22 | 0.028 | X | X | 0.878 | 1.897 |
| 23 | 0.031 | X | X | 0.872 | 1.898 |
| 24 | 0.033 | X | X | 0.865 | 1.901 |
| 25 | 0.035 | X | X | 0.846 | 1.899 |
| 26 | 0.038 | ◯ | X | 0.828 | 1.912 |
| 27 | 0.04 | ◯ | X | 0.821 | 1.923 |
| 28 | 0.041 | ◯ | ◯ | 0.816 | 1.923 |
| 29 | 0.044 | ◯ | ◯ | 0.811 | 1.915 |
| 30 | 0.046 | ◯ | ◯ | 0.815 | 1.922 |
| 31 | 0.049 | ◯ | ◯ | 0.822 | 1.922 |
| 32 | 0.052 | ◯ | X | 0.823 | 1.915 |
| 33 | 0.054 | ◯ | X | 0.813 | 1.92 |
| 34 | 0.058 | X | X | 0.845 | 1.909 |
| 35 | 0.059 | X | X | 0.857 | 1.907 |
| 36 | 0.062 | X | X | 0.887 | 1.907 |
| 37 | 0.065 | X | X | 0.884 | 1.891 |
| 38 | 0.067 | X | X | 0.881 | 1.899 |
| 39 | 0.068 | X | X | 0.877 | 1.901 |
| 40 | 0.071 | X | X | 0.871 | 1.898 |
| 41 | 0.074 | X | X | 0.879 | 1.898 |

As shown in Table 3, it can be confirmed that among the invention materials, the invention material that satisfies Formula 2 has more excellent magnetism. In addition, it can be confirmed that among the invention materials that satisfy Formula 2, the invention material that simultaneously satisfies Formula 3 has more excellent magnetism.

### EXAMPLE 3

A slab that includes Si at 3.4 wt%, Al at 0.027 wt%, N at 0.005 wt%, S at 0.004 wt%, Sb at 0.02 wt%, Sn at 0.07 wt%, P at 0.03 wt%, Cr at 0.04 wt%, Co at 0.03 wt%; the contents of C and Mn changed as shown in Table 4; and the balance of Fe and other inevitable impurities was heated at a temperature of 1150° C. and then hot-rolled to a thickness of 2.3 mm. The hot-rolled sheet was heated at a temperature of 1080° C., maintained at 890° C. for 160 seconds, and quenched in water. The hot-rolled annealing sheet was pickled and rolled once to a thickness of 0.23 mm, and the cold-rolled sheet was maintained for 200 seconds in a humid hydrogen, nitrogen, and ammonia mixed gas atmosphere at a temperature of 860° C., and then simultaneously decarbonitized, nitrided, annealed, and heat-treated so that the nitrogen content was 180 ppm and the carbon content was 30 ppm.

The final annealing was performed by applying MgO, an annealing separating agent, to this steel sheet, and in this case, the final annealing was performed in a mixed atmosphere of 25 vol% nitrogen+75 vol% hydrogen until 1200° C., and after reaching 1200° C., it was maintained for 10 hours or more in a 100 vol% hydrogen atmosphere and then furnace-cooled. Table 4 shows the measured magnetic characteristics for each condition.

TABLE 4

| | | | | | | Mag- | |
|---|---|---|---|---|---|---|---|
| | | | Whether | Whether | Iron | netic | |
| | | | Formula | Formula | loss | flux | |
| Steel | | | 2 is | 3 is | (W17/ | density | |
| type | Mn | C | satisfied | satisfied | 50) | B8 | |
| 42 | 0.09 | 0.041 | X | X | 0.874 | 1.906 | Comparative |
| | | | | | | | material |
| 43 | 0.11 | 0.076 | X | X | 0.871 | 1.906 | Comparative |
| | | | | | | | material |
| 44 | 0.2 | 0.036 | X | X | 0.873 | 1.904 | Inventive |
| | | | | | | | material |
| 45 | 0.22 | 0.054 | O | O | 0.822 | 1.905 | Inventive |
| | | | | | | | material |
| 46 | 0.21 | 0.074 | X | X | 0.881 | 1.901 | Inventive |
| | | | | | | | material |
| 47 | 0.31 | 0.034 | X | X | 0.884 | 1.889 | Inventive |
| | | | | | | | material |
| 48 | 0.29 | 0.05 | O | O | 0.812 | 1.909 | Inventive |
| | | | | | | | material |
| 49 | 0.31 | 0.066 | X | X | 0.877 | 1.898 | Inventive |
| | | | | | | | material |
| 50 | 0.41 | 0.027 | X | X | 0.882 | 1.902 | Inventive |
| | | | | | | | material |
| 51 | 0.4 | 0.045 | O | O | 0.827 | 1.917 | Inventive |
| | | | | | | | material |
| 52 | 0.4 | 0.062 | X | X | 0.879 | 1.897 | Inventive |
| | | | | | | | material |
| 53 | 0.5 | 0.023 | X | X | 0.871 | 1.883 | Inventive |
| | | | | | | | material |
| 54 | 0.5 | 0.04 | O | O | 0.816 | 1.908 | Inventive |
| | | | | | | | material |
| 55 | 0.52 | 0.052 | X | X | 0.881 | 1.892 | Inventive |
| | | | | | | | material |
| 56 | 0.61 | 0.021 | X | X | 0.879 | 1.89 | Inventive |
| | | | | | | | material |
| 57 | 0.61 | 0.034 | O | O | 0.816 | 1.895 | Inventive |
| | | | | | | | material |
| 58 | 0.61 | 0.048 | X | X | 0.887 | 1.891 | Inventive |
| | | | | | | | material |
| 59 | 0.72 | 0.016 | X | X | 0.884 | 1.875 | Inventive |
| | | | | | | | material |
| 60 | 0.71 | 0.03 | O | O | 0.815 | 1.891 | Inventive |
| | | | | | | | material |
| 61 | 0.7 | 0.043 | X | X | 0.881 | 1.882 | Inventive |
| | | | | | | | material |
| 62 | 0.8 | 0.01 | X | X | 0.882 | 1.876 | Inventive |
| | | | | | | | material |
| 63 | 0.81 | 0.024 | O | O | 0.826 | 1.887 | Inventive |
| | | | | | | | material |
| 64 | 0.81 | 0.037 | X | X | 0.888 | 1.874 | Inventive |
| | | | | | | | material |
| 65 | 0.89 | 0.008 | X | X | 0.883 | 1.875 | Inventive |
| | | | | | | | material |
| 66 | 0.90 | 0.021 | O | O | 0.823 | 1.887 | Inventive |
| | | | | | | | material |
| 67 | 0.98 | 0.029 | X | X | 0.871 | 1.881 | Inventive |
| | | | | | | | material |
| 68 | 1.07 | 0.002 | X | X | 0.876 | 1.872 | Comparative |
| | | | | | | | material |
| 69 | 1.1 | 0.01 | O | O | 0.889 | 1.874 | Comparative |
| | | | | | | | material |
| 70 | 1.09 | 0.023 | X | X | 0.883 | 1.871 | Comparative |
| | | | | | | | material |

As shown in Table 4, it can be confirmed that among the invention materials, the invention material that satisfies Formula 2 and Formula 3 has more excellent magnetism.

The present invention may be embodied in many different forms, and should not be construed as being limited to the disclosed embodiments and/or examples. In addition, it will be understood by those skilled in the art that various changes in form and details may be made thereto without departing from the technical spirit and essential features of the present invention. Therefore, it is to be understood that the above-described embodiments and/or examples are for illustrative purposes only, and the scope of the present invention is not limited thereto.

1. A grain-oriented electrical steel sheet includes: Si at 2.0 to 6.0 wt%, Mn at 0.12 to 1.0 wt%, Sb at 0.01 to 0.05 wt%, Sn at 0.03 to 0.08 wt%, Cr at 0.01 to 0.2 wt%, and the balance of Fe and inevitable impurities, and satisfies Formula 1 below:
4×[Cr]−0.1×[Mn]≥0.5×([Sn]+[Sb]) [Formula 1]
(in Formula 1, [Cr], [Mn], [Sn], and [Sb] represent contents (wt%) of Cr, Mn, Sn, and Sb, respectively).

2. The grain-oriented electrical steel sheet of claim 1, further comprising Al at 0.005 to 0.04 wt% and P at 0.005 to 0.045 wt%.

3. The grain-oriented electrical steel sheet of claim 1, further comprising Co at 0.1 wt% or less.

4. The grain-oriented electrical steel sheet of claim 1, further comprising C at 0.01 wt% or less, N at 0.01 wt% or less, and S at 0.01 wt% or less.

5. A manufacturing method of a grain-oriented electrical steel sheet, comprising:
heating a slab including Si at 2.0 to 6.0 wt%, C at 0.01 to 0.15 wt%, Mn at 0.12 to 1.0 wt%, Sb at 0.01 to 0.05 wt%, Sn at 0.03 to 0.08 wt%, Cr at 0.01 to 0.2 wt%, and the balance of Fe and inevitable impurities, and satisfying Formula 1 below;
hot-rolling the slab to manufacture a hot rolled sheet;
cold-rolling the hot-rolled sheet to produce a cold-rolled sheet;
primary recrystallization annealing the cold-rolled sheet; and
secondary recrystallization annealing the cold-rolled sheet subjected to the primary recrystallization annealing
4×[Cr]−0.1×[Mn]≥0.5×([Sn]+[Sb]) [Formula 1]
(in Formula 1, [Cr], [Mn], [Sn], and [Sb] represent contents (wt%) of Cr, Mn, Sn, and Sb, respectively).

6. The manufacturing method of the grain-oriented electrical steel sheet of claim 5, wherein
the slab satisfies Formula 2:
2×(1.3−[Mn])−2×(3.4−[Si])≤50×[C]≤3×(1.3−[Mn])−2×(3.4−[Si]) [Formula 2]
(in Formula 2, [Mn], [Si], and [C] represent contents (wt%) of Mn, Si, and C in the slab, respectively).

7. The manufacturing method of the grain-oriented electrical steel sheet of claim 5, wherein
the slab satisfies Formula 3:
5×(1.3−[Mn])−4×(3.4−[Si])−0.5 ≤100×[C]≤5×(1.3−[Mn])−4×(3.4−[Si])+0.5 [Formula 3]
(in Formula 3, [Mn], [Si]. and [C] represent contents (wt%) of Mn, Si, and C in the slab, respectively).

8. The manufacturing method of the grain-oriented electrical steel sheet of claim 5, wherein
the heating of the slab includes heating at a temperature of 1250° C. or less.

9. The manufacturing method of the grain-oriented electrical steel sheet of claim 5, wherein
after the manufacturing of the hot-rolled sheet, annealing the hot-rolled sheet is further included, wherein a crack temperature of the annealing of the hot rolled sheet is 800 to 1300° C.

10. The manufacturing method of the grain-oriented electrical steel sheet of claim 5, wherein
the manufacturing of the cold-rolled sheet includes cold-rolling once, or cold-rolling two times or more including intermediate annealing.

11. The manufacturing method of the grain-oriented electrical steel sheet of claim 5, wherein
the primary recrystallization annealing includes decarburizing and nitriding, and
the nitriding is performed after the decarburizing, or
the decarburizing is performed after the nitriding, or
the decarburizing and the nitriding are simultaneously performed.

12. The manufacturing method of the grain-oriented electrical steel sheet of claim 5, further comprising
after the primary recrystallization annealing, applying an annealing separating agent.

13. The manufacturing method of the grain-oriented electrical steel sheet of claim 5, wherein
the secondary recrystallization annealing includes completing secondary recrystallization at a temperature of 900 to 1210° C.
